(19) United States
(12) Patent Application Publication
(10) Pub. No.: US 2011/0000309 A1
(43) Pub. Date: Jan. 6, 2011

(54) APPARATUS FOR MEASURING PARAMETERS OF FLUID FLOW

(75) Inventors: Clive Javan Griffiths, Newcastle-upon-Tyne (GB); Jennifer Caffarel, Brampton (GB); Michael Whitaker, Newcastle-upon-Tyne (GB); Michael James Drinnan, Alnwick (GB)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: THE NEWCASTLE UPON TYNE HOSPITALS NHS TRUST, Newcastle-upon-Tyne, Tyne and Wear (GB)

(21) Appl. No.: 12/809,881

(22) PCT Filed: Dec. 18, 2008
(86) PCT No.: PCT/GB2008/051197

§ 371 Date: Sep. 10, 2010

(30) Foreign Application Priority Data
Dec. 21, 2007 (GB) 0724966.7

(51) Int. Cl. G01F 1/56

(52) U.S. Cl. 73/861.08

(57) ABSTRACT

A flow rate measuring apparatus comprises a vessel for receiving electrically conductive liquid, and a measuring element for measuring electrically the filled volume of the vessel as a function of time to provide a signal representative of the flow rate of electrically conductive liquid entering the vessel. The measuring element is disposable within the vessel and is configured to regulate the flow of electrically conductive liquid from the first side to the second side of the measuring element.

The present invention relates to an improved apparatus for measuring parameters of fluid flow. Although the present invention has applications in numerous areas of technology, the present invention is particularly, although not exclusively suitable for use in the measurement of parameters of fluid flow such as:—the peak flow rate of urine during voiding (i.e. emptying) of the bladder of a patient; the changes in the flow rate of urine over time during voiding of the bladder of a patient; the total volume of urine voided from the bladder of a patient; and the times of day at which the bladder of a patient is voided. In this way, the present invention can be used to assess the function of the bladder and/or the urethra of a patient.

Uroflowmetry, the measurement of the flow rate of urine during voiding of the bladder of a patient, is normally performed in a clinic using a clinic based flow meter. As with any physiological variable, the flow of urine has natural variability and as such in order to obtain a reliable measurement of the flow rate, it is often the case that several measurements are taken and a representative flow rate is used. However, in order to achieve this, a patient has to repeatedly fill their bladder, which can take up a considerable amount of time in the clinic (sometimes up to half a day or even longer). Moreover, the patient is required to perform a number of voids under artificial conditions, which can be distressing and inconvenient for the patient.

In order to solve this problem, it is known practice to allow the patient to measure their own peak flow rates as naturally as possible at home, and then relay the information to the clinic for assessment by the clinician. Very basic peak flow measurements are therefore sometimes carried out by the patient in their own home using for example a simple low cost funnel device that requires the patient to observe the maximum height reached by urine in the device during voiding of their bladder. Whilst this type of device provides a very useful pre-test evaluation of a patient's voiding function, particularly when the patient first visits their GP surgery, the patient is required to record their own measurements and some degree of judgement is required. Moreover, this type of device is only able to provide information about the peak flow rate of urine during voiding of the bladder of a patient, and is not generally able to provide a clinician with information about other flow parameters such as:—the changes in flow rate of urine over time during voiding of the bladder of a patient; the total volume of urine voided from the bladder of a patient; and the times of day at which the bladder of a patient is voided.

It is to be appreciated that it is not normally practicable to carry out a natural, home-based type of procedure using a clinic based flow meter, since clinic based flow meters are very expensive and require operation by trained personnel only.

An aim of the present invention is to provide an apparatus which overcomes or at least alleviates the problems associated with known devices for measuring urine flow parameters.

In particular, it is an aim of the present invention to provide an apparatus which is simple and low cost and thereby able to be used in the patient's home, yet provides a clinician with reliable results which can be used to accurately assess the function of the bladder and/or the urethra of a patient.

In accordance with a first aspect of the present invention there is provided a flow rate measuring apparatus, said apparatus comprising:
(i) a vessel for receiving electrically conductive liquid; and
(ii) a measuring element for measuring electrically the filled volume of the vessel as a function of time to provide a signal representative of the flow rate of electrically conductive liquid entering the vessel, said measuring element having a first side and a second side,

wherein said measuring element is disposable within said vessel and is configured to regulate the flow of electrically conductive liquid from the first side to the second side.

In having a measuring element for measuring the filled volume of the vessel as a function of time which is configured to regulate the flow of the electrically conductive liquid entering the vessel, this provides the advantage that the flow of the electrically conductive liquid within the vessel can be made to be more laminar. This provides the resulting advantage that the signal representative of the flow rate of electrically conductive liquid entering the vessel includes less artefacts than would otherwise be the case. In the case where the apparatus is used in the field of uroflowmetry, this in turn means that more reliable measurements of the flow rate of urine during voiding of the bladder of a patient can be obtained.

Moreover, in having a measuring element for measuring the filled volume of the vessel as a function of time which is configured to regulate the flow of electrically conductive liquid entering the vessel, the apparatus is able to provide reliable results at comparatively low cost, in view of the ease of the manufacturing process involved in having a single element of the apparatus which performs both of these functions. In providing for a low cost yet reliable measuring apparatus, the apparatus lends itself to being used in a patient's home, which reduces the amount of clinic time required to assess the function of the bladder and/or urethra of a patient. Moreover, in being able to use the apparatus at home, the patient does not have to remain in the clinic for long periods of time, which can otherwise be distressing for the patient and time consuming for personnel at the clinic.

In this way, the present invention is able to bridge the gap between the expensive and difficult to use yet reliable clinic based devices, and the low cost devices which require judgement on behalf of the patient but which nevertheless allow the patient to assess their own flow rate in their own home.

In view of its relatively low manufacturing costs, the apparatus may be at least semi-disposable, whereby the apparatus may be used several times by one patient or even several times by more than one patient, before being disposed of. This in turn enables clinicians to distribute the apparatus freely to many patients for use in their own home.

Preferably, said measuring element comprises a sensing element which comprises a first electrical conductor electrically insulated from electrically conductive liquid entering the vessel.

Said measuring element may further comprise a lid having an aperture configured to direct electrically conductive fluid entering the vessel towards an inner wall of the vessel.

The apparatus may further comprise a grounded electrically conductive element which is disposed at or near the base of the vessel.

It is to be appreciated that the location of the grounded electrically conductive element is such that electrically conductive liquid in the vessel is able to make contact with it.

Alternatively, the vessel may be made from grounded electrically conductive material.

It is to be appreciated that the term “grounded” used herein means connected to the circuit reference potential, which may or may not be connected to true earth. It is to be appreciated that any suitable circuit reference potential could be used, for example, but by no means limited to, 0 volts or 2.5 volts.

Preferably, said sensing element comprises a grounded electrically conductive element, a dielectric element of a capacitor, and a first electrical conductor disposed between the grounded electrically conductive element and the dielectric element.

Preferably, said sensing element further comprises an electrical insulator disposed between the grounded electrically conductive element and the first electrical conductor.

In this way, the first electrical conductor is electrically insulated from electrically conductive liquid entering the vessel.

Preferably, said sensing element is adapted to change its capacitance in accordance with the time-dependent amount of electrically conductive liquid in the vessel.

In this way, the first electrical conductor effectively functions as the first plate of the capacitor and urine entering the vessel effectively functions as the second plate of the capacitor. It follows that the capacitance changes, for example, increases, as the amount of urine in the vessel increases, since there is more capacitive coupling between the first plate and the second plate as the vessel fills with urine.

In associating the amount of urine in the vessel with the capacitance, this provides the advantage that the apparatus is relatively inexpensive to manufacture, easy to clean, and is readily able to provide a signal indicative of the flow rate of electrically conductive liquid entering the vessel by means of measuring the capacitance at various times during voiding by the patient.

Preferably, said apparatus is adapted so that electrically conductive liquid entering the vessel flows in a direction such that it makes contact with said dielectric element only after it has made contact with the grounded electrically conductive element.

In this way, significant capacitive coupling only occurs when the flow of electrically conductive liquid entering the vessel has been regulated by for example, making its flow more laminar.

Preferably, a path formed between the first side and the second side is defined by a gap between the sensing element and a wall of the vessel, preferably the base thereof.

Alternatively, a path formed between the first side and the second side is defined by at least one aperture in the sensing element.

The flow of urine entering the vessel can be turbulent. In adapting the apparatus so that electrically conductive liquid entering the vessel makes contact with the grounded electrically conductive element before it makes contact with the dielectric element, this provides the advantage that any turbulent flow is made more laminar before it makes contact with the dielectric element, thereby reducing artefacts to provide more reliable results.

The sensing element may additionally comprise a further electrical insulator disposed on said grounded electrically conductive element on the opposite side thereof to the first electrical conductor.

In this way, the further electrical insulator may form an outer layer of the sensing element.

Preferably, the measuring element further comprises electronic circuitry for utilizing the changes in capacitance over time as the electrically conductive liquid enters the vessel to generate a signal representative of the flow rate of the electrically conductive liquid entering the vessel.

Preferably, the measuring element further comprises a data storage device which is able to store data relating to the flow rate of the electrically conductive liquid entering the vessel.

This provides the advantage that the rate of flow of urine for example, can be calculated at various times during one particular voiding of the bladder of a patient to provide a plot showing the variation of the flow rate of urine during voiding. Moreover, as well as facilitating the measurement of the flow rate during one particular voiding, the flow rates of urine can be calculated at various times of the day and the associated data stored. In this way, the clinician is provided with a true “electronic voiding diary” which can provide information relating to the variation of the flow rate of urine during voiding, and the variation of the flow rates at different times of the day. This in turn provides the clinician with the means to more accurately assess the true peak flow rate of urine, for example, since it is not necessary to rely only upon a single measurement of the peak flow rate of urine.

In providing an electronic voiding diary, this provides the further advantage that neither the patient nor the clinician is required to make hand written notes regarding the flow rate of urine during voiding by the patient, thereby reducing inconvenience and possible inaccuracies in measurement.

The apparatus may be adapted so that data recorded on the data storage device is able to be downloaded onto a PC and analysed using software.

This provides the advantage that the clinician is able to assess the function of the bladder and/or the urethra of a patient in their own time and with the aid of reliable results obtained with little inconvenience to the patient.

The apparatus may be further adapted to provide a user with information relating to the total volume of electrically conductive liquid entering the vessel in a pre-determined time frame.

The apparatus may be further adapted to provide a user with information relating to the time taken for a pre-determined volume of electrically conductive liquid to enter the vessel.

In this way, the apparatus is able to provide the clinician with yet further information relating to parameters other than the flow rate, associated with the flow of urine during voiding by a patient.

The apparatus may further include a power supply.

This provides the advantage that the apparatus is portable.

The apparatus may be adapted so that the measuring element continuously measures the filled volume of the vessel as a function of time, for a period of time. For example, the apparatus may be adapted so that the measuring element continuously measures the filled volume of the vessel as a function of time for a period of several weeks. It is to be appreciated that the duration of the period of time over which the apparatus is continuously operational in this way is only limited by the lifetime of the power supply and/or the amount of data storage available.

This provides the advantage that the patient is not required to switch the apparatus on and off before and after use, respectively, thereby reducing inconvenience to the patient. Instead, all that is required of the patient is that they empty and rinse the apparatus after each use. To elaborate, the apparatus is permanently “switched on” and continuously measures the filled volume of the vessel (which may be zero before and after use, for example) over time. This is made feasible in view of the long life of the power supply and the relatively low cost of the data storage device which may be utilised.

In accordance with a second aspect of the present invention there is provided a flow rate measuring apparatus, said apparatus comprising a measuring element for measuring electrically the filled volume of a vessel as a function of time to provide a signal representative of the flow rate of electrically conductive liquid entering a vessel, said measuring element having a first side and a second side, wherein said measuring element is disposable within a vessel and is configured to regulate the flow of electrically conductive liquid from the first side to the second side, and wherein said measuring element measures capacitance and includes a first electrical conductor electrically insulated from electrically conductive liquid entering the vessel, characterised in that electrically conductive liquid disposed within the vessel functions as a second plate of the capacitor.

Preferred embodiments of the present invention will now be described, by way of example only and not in any limitative sense, with reference to the accompanying drawings in which:

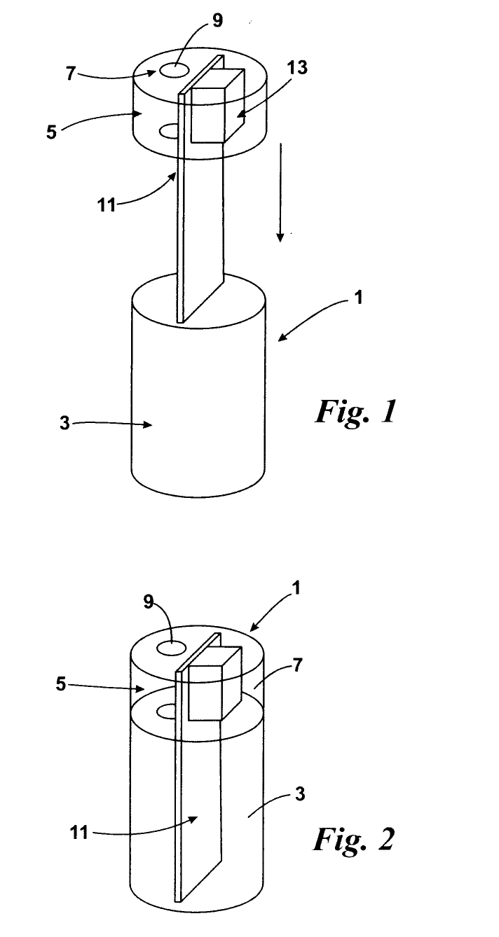

FIG. 1 shows an exploded perspective view of an apparatus in accordance with a first embodiment of the present invention;

FIG. 2 shows a perspective view of the apparatus of FIG. 1;

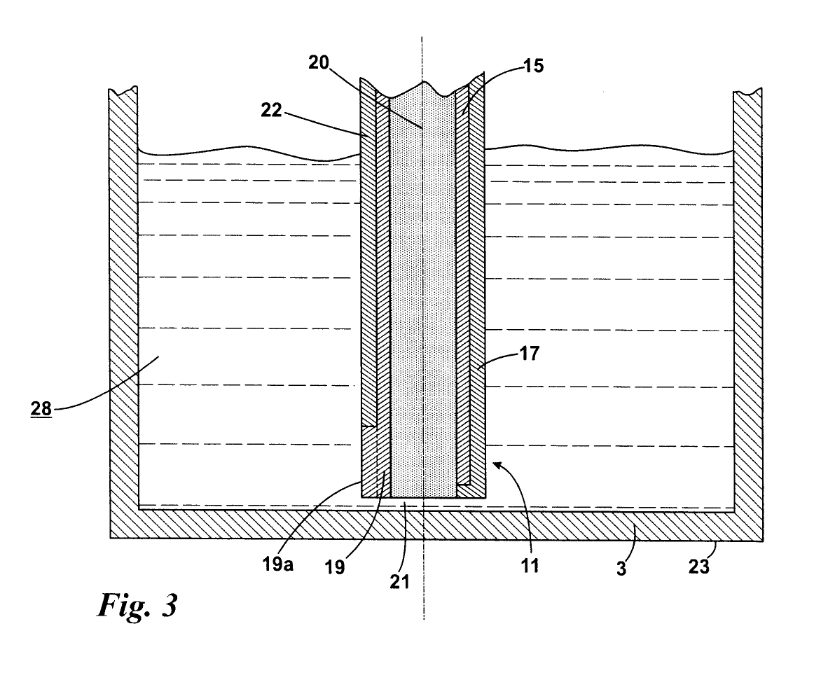

FIG. 3 shows a cross sectional view of a portion of an apparatus in accordance with a first embodiment of the present invention;

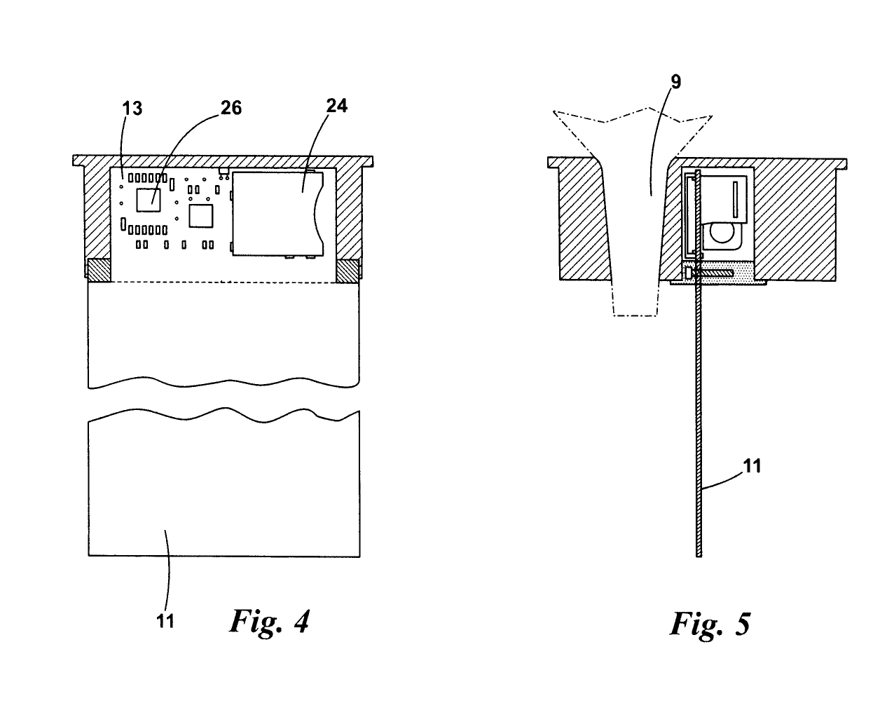

FIG. 4 shows a front view showing hidden detail of a measuring element, said measuring element forming a portion of the apparatus in accordance with a first embodiment of the present invention;

FIG. 5 shows a view from one side of the measuring element shown in FIG. 4, showing hidden detail;

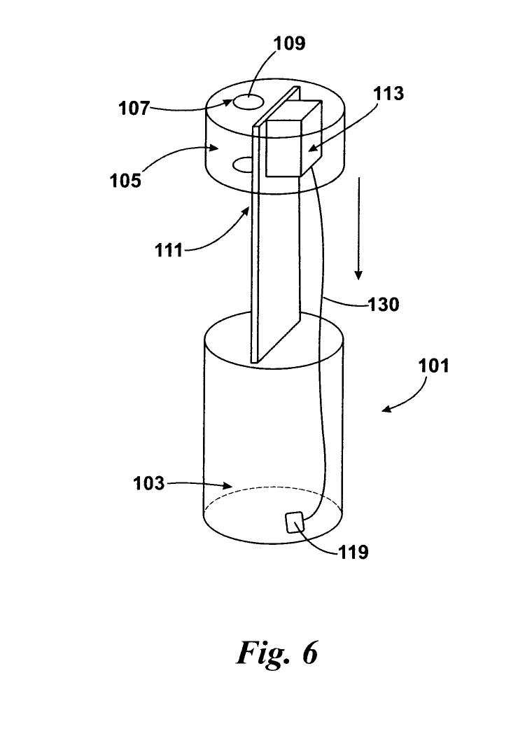

FIG. 6 shows an exploded perspective view of an apparatus in accordance with a second embodiment of the present invention;

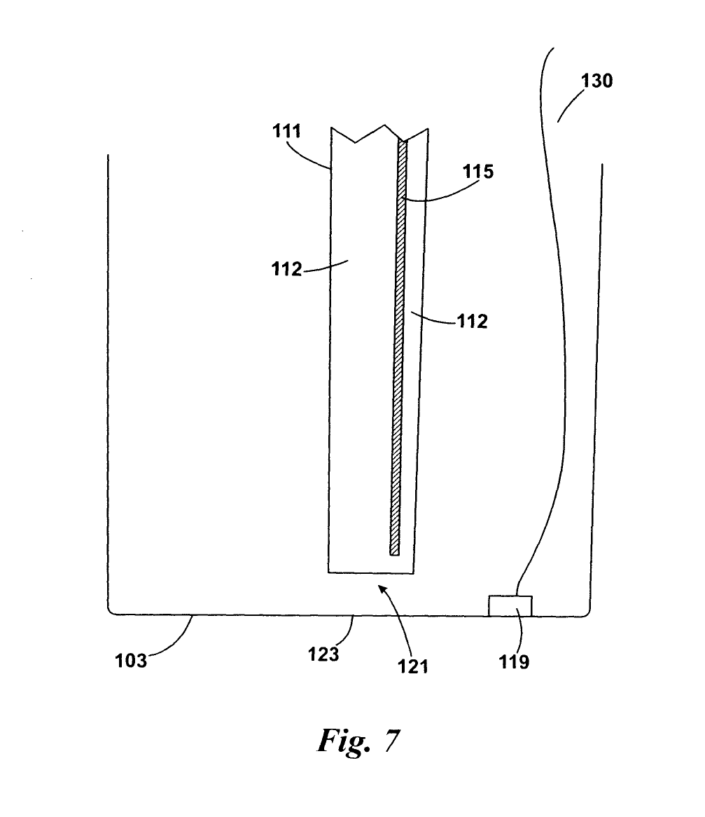

FIG. 7 shows a cross sectional view of a portion of an apparatus in accordance with a second embodiment of the present invention;

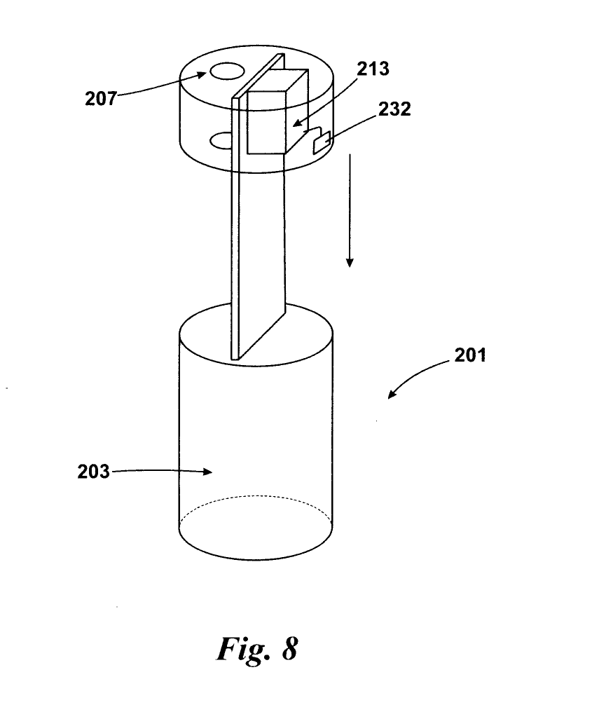

FIG. 8 shows an exploded perspective view of an apparatus in accordance with a third embodiment of the present invention; and

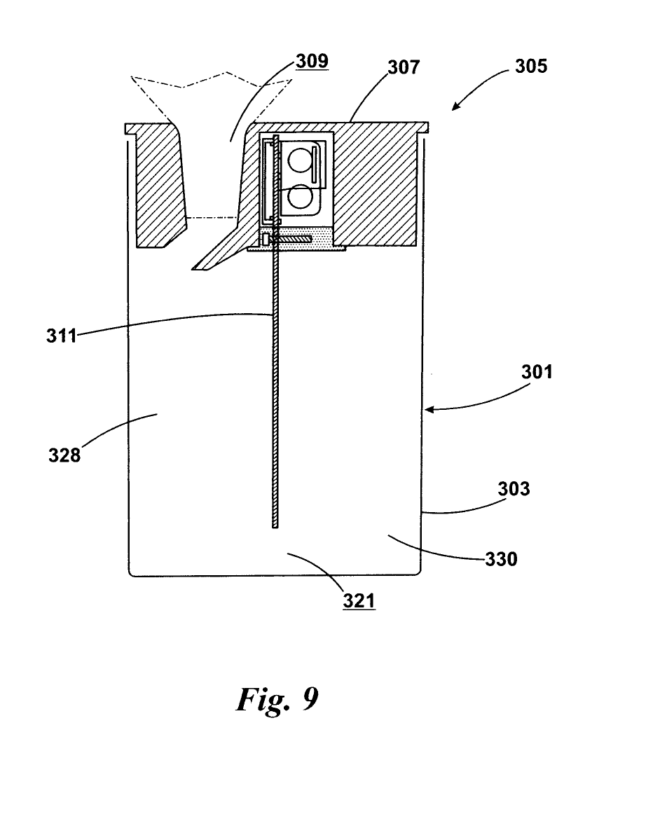

FIG. 9 shows an exploded perspective view of an apparatus in accordance with a fourth embodiment of the present invention.

Referring to FIGS. 1 to 5, there is shown a first embodiment of a flow rate measuring apparatus 1 suitable for measuring electrically the flow rate of an electrically conductive liquid.

It is to be appreciated that although the foregoing describes the operation of the invention as a means of measuring parameters associated with the flow of urine during voiding of the bladder by a patient, the apparatus could in fact be utilized to measure parameters associated with the flow of any suitable electrically conductive fluid.

The apparatus 1 comprises:—a vessel 3 in the form of a standard issue plastic beaker for example; and a measuring element 5 for measuring the filled volume of the vessel as a function of time to provide a signal representative of the flow rate of electrically conductive liquid entering the vessel.

The measuring element 5 for measuring the filled volume of the vessel 3 as a function of time comprises a sensing element 11, which is shown in detail in FIG. 3, coupled to electronic circuitry 13. The measuring element 5 further comprises a lid 7 having an aperture 9 for receiving a funnel (not shown) to direct the flow of urine into the vessel 3.

The sensing element 11 comprises a first electrical conductor in the form of a first electrically conductive plate 15, and a dielectric element in the form of a dielectric layer 17 which is in contact with said first electrically conductive plate 15. The sensing element 11 further comprises a grounded electrically conductive element in the form of a grounded electrically conductive plate 19, which is in contact with an electrical insulator in the form of a fiberboard layer 20. The fiberboard layer 20 is sandwiched between the grounded electrically conductive plate 19 and the first electrically conductive plate 15 and functions to electrically insulate the first electrically conductive plate 15 from any urine in the vessel 3, and also to help support the sensing element 11.

The electrically conductive plate 19 is grounded for practical reasons to prevent short circuiting, since the patient could possibly come into contact with this portion of the apparatus 1. The sensing element 11 further comprises a further electrical insulator in the form of a layer 22 which is in contact with the grounded electrically conductive plate 19 on the opposite side of the grounded electrically conductive plate 19 to the fiberboard layer 20.

The layers 15, 17, 19 and 20 have substantially the same surface area as each other and in this way, the layers 15, 17, 19 and 20 are in touching contact with each other and completely overlap each other. The layer 22 however, is disposed so that it only partially overlaps the grounded electrically conductive plate 19, with the result that a strip portion 19a of the grounded electrically conductive plate 19 is exposed towards the bottom part of the sensing element 11. The strip portion 19a is made from tin and the remainder of the grounded electrically conductive plate 19 is made from copper. The layer 22 thereby functions to reduce the amount of tin plating necessary in the apparatus, since it is only the exposed portion 19a which is made from tin, as opposed to the entire surface of the grounded electrically conductive plate 19 which would otherwise be tin plated were it not for the presence of the layer 22.

As can be seen from FIGS. 4 and 5 in particular, the sensing element 11 is integrally formed with the lid 7. In this way, the lid 7 can be easily located on the vessel 3 with the result that the sensing element 11 is securely retained in position in the vessel 3 when the lid 7 is correctly located on the vessel 3.

The lid 7 houses the electronic circuitry 13, which is electrically connected to the grounded electrically conductive plate 19 and the first electrically conductive plate 15 respectively. The electronic circuitry 13 incorporates a processor 26 which facilitates the measurement of the capacitance at various time intervals during voiding by the patient and converts these measurements into parameters of interest to the clinician, such as the flow rate of urine entering the vessel 3. The electronic circuitry 13 further includes a data storage device in the form of a memory card 24 upon which is stored data processed by the processor 26 relating to the urine flow parameters.

It is to be appreciated that the sensing element 11 may be removable from the lid 7 in the event that the user requires access to the electronic circuitry 13, for example to replace the memory card or a power supply incorporated in the electronic circuitry 13.

The sensing element 11 is configured so that it takes the form of a one-piece, layered plate, which has a shape and size which substantially matches that of a cross section of the interior of the vessel 3. In this way, when the lid 7 is in situ on the vessel 3, the sensing element 11 fits neatly into the vessel 3 with only a small gap 21 between the base 23 of the vessel 3 and the sensing element 11. In this way, the sensing element 11 effectively divides the apparatus 1 and in particular the vessel 3 into two parts:—namely the “ground side” 28 which has its boundary formed by the vessel 3 and the grounded electrically conductive plate 19; and the “sensitive side” 30 which has its boundary formed by the vessel and the dielectric layer 17.

The lid 7 and in particular the aperture 9 is configured so that when the lid 7 is in situ on the vessel 3, the urine enters the vessel 3 on the ground side 28. In this way, the urine has to travel from the ground side to the sensitive side before capacitive coupling (which will be described in further detail below) occurs between the first electrically conductive plate 15 acting as the first plate of the capacitor and the urine acting as the second plate of the capacitor. The configuration of the sensing element 11 ensures that the urine travels from the ground side 28 to the sensitive side 30 of the apparatus via the gap 21. In this way, the measuring element 5 and in particular the sensing element 11 functions as a baffle as well as a means for measuring the capacitance. To elaborate, as urine enters the vessel 3 on the ground side 28, any turbulence such as ripples and splashes remain on the ground side 28. The presence of the gap 21 allows the urine level to then rise in a more laminar fashion on the sensitive side 30, with the result that artefacts in the measurement of capacitance are reduced.

It is to be appreciated that in an alternative embodiment, the path between the ground side 28 and the sensitive side 30 of the capacitor may be defined by an aperture in the sensing element 11.

The urine in the vessel 3 is electrically conductive, and in the event that there is urine present on the sensitive side 30 (that is, once the urine has entered the vessel 3 and passed from the ground side 28 to the sensitive side 30 via the gap 21), the urine acts as the second plate of a capacitor and the first electrically conductive plate 15 acts as the first plate of the capacitor, with the dielectric layer 17 disposed therebetween.

As the urine level in the vessel 3 increases on the sensitive side 38, the area of contact between the urine and the dielectric layer 17 increases, with the result that the capacitive coupling between the urine acting as the second plate of the capacitor and the first electrically conductive plate 15 acting as the first plate of the capacitor, increases, with the result that the capacitance also increases.

The electronic circuitry 13 calculates the capacitance at various times during the voiding process and converts this data into the various parameters which are of potential interest to the clinician, such as:—the peak flow rate of urine during voiding of the bladder of a patient; the changes in the flow rate of urine over time during voiding of the bladder of a patient; the total volume of urine voided from the bladder of a patient; and the times of day at which the bladder of a patient is voided.

To elaborate, the electronic circuitry measures the capacitance by means of feeding a known current into the sensing element 11 and measures the time taken to reach a known reference voltage, thereby providing an indication of the value of the capacitance. The capacitance is directly proportional to the filled volume of the vessel 3 and so the change in the filled volume of the vessel over time can be derived from the change in capacitance over time, thereby providing an indication of the flow rate of urine during voiding of the bladder of a patient. It follows that the absolute final value of the capacitance reached during one particular void of the bladder of the patient can be directly related to the filled volume of the vessel, thereby providing an indication of the total volume of urine voided from the bladder of a patient.

In this way, the present invention can be used to assess the function of the bladder of a patient.

The electronic circuitry 13 further comprises a clock device (not shown) which facilitates the timing of voids and the measurement of the time of day at which voiding occurs.

Referring now to FIGS. 6 and 7, there is shown a second embodiment of a flow rate measuring apparatus 101 suitable for measuring electrically the flow rate of an electrically conductive liquid.

The apparatus 101 is similar to that shown in FIGS. 1 to 5, and comprises:—a vessel 103 in the form of a standard issue plastic beaker for example; a measuring element 105 for measuring the filled volume of the vessel as a function of time to provide a signal representative of the flow rate of electrically conductive liquid entering the vessel; and a grounded electrically conductive element 119 disposed on the base of the vessel 103.

The measuring element 105 for measuring the filled volume of the vessel 103 as a function of time comprises a lid 107 having an aperture 109 for receiving a funnel (not shown) to direct the flow of urine into the vessel 103, along with a sensing element 111, which is shown in detail in FIG. 7. The sensing element 111 is electrically coupled to electronic circuitry 113, and comprises a first electrical conductor in the form of a first electrically conductive plate 115, which is coated on both of its sides with an electrically insulating material 112 and as such is electrically insulated from its surroundings and in particular any urine entering the vessel 103. It is to be noted that the electrical insulation 112 on one side of the first electrically conductive plate 115 is thicker than the electrical insulation 112 on the other side of the first electrically conductive plate 115 and the reasons for this will be explained later.

As can be seen from FIGS. 6 and 7, the sensing element 111 is integrally formed with the lid 107. In this way, the lid 107 can be easily located on the vessel 103 with the result that the sensing element 111 is securely retained in position in the vessel 103 when the lid 107 is correctly located on the vessel 103.

As with the first embodiment, the lid 107 houses the electronic circuitry 113, which in this embodiment is electrically connected to the first electrically conductive plate 115 and a grounded electrically conductive element 119 (via electrical connector 130), respectively. As with the first embodiment, the electronic circuitry 113 facilitates the measurement of the capacitance at various time intervals during voiding by the patient and converts these measurements into parameters of interest to the clinician, such as the flow rate of urine entering the vessel 103.

The sensing element 111 is configured so that it takes the form of a one-piece, layered plate, which has a shape and size which substantially matches that of a cross section of the interior of the vessel 103. In this way, when the lid 107 is in situ on the vessel 103, the sensing element 111 fits neatly into the vessel 103 with only a small gap 121 between the base 123 of the vessel 103 and the sensing element 111.

The lid 107 and in particular the aperture 109 is configured so that when the lid 107 is in situ on the vessel 103, the urine enters the vessel 103 on the side of the sensing element 111 which has the thicker layer of electrical insulation 112 disposed thereon. In this way, the urine has to travel, via the gap 121 from the side of the sensing element 111 having the thicker layer of electrical insulation 112 to the side of the sensing element 111 having the thinner layer of electrical insulation 112 before significant capacitive coupling occurs between the first electrically conductive plate 115 acting as the first plate of the capacitor and the urine acting as the second plate of the capacitor. In this way, the measuring element 105 and in particular the sensing element 111 functions as a baffle as well as a means for measuring the capacitance.

As with the first embodiment, the electronic circuitry 113 calculates the capacitance at various times during the voiding process and converts this data into the various parameters which are of potential interest to the clinician, such as:—the peak flow rate of urine during voiding of the bladder of a patient; the changes in the flow rate of urine over time during voiding of the bladder of a patient; the total volume of urine voided from the bladder of a patient; and the times of day at which the bladder of a patient is voided.

Referring now to FIG. 8, there is shown a third embodiment of a flow rate measuring apparatus 201 suitable for measuring electrically the flow rate of an electrically conductive liquid.

The apparatus 201 is similar to that shown in FIGS. 6 and 7, but for the provision of a vessel 203 which is made from an electrically conductive material such as copper, which functions as a grounded electrically conductive element. The apparatus 201 includes an electrical connector 232 disposed inside the lid 207. The electrical connector 232 is electrically connected to electronic circuitry 213 in the lid 207 and is disposed such that when the lid is in situ on the vessel 203, the electrical connector 232 contacts the grounded electrically conductive vessel 203. The remainder of the apparatus 201 functions in the same way as the apparatus shown in FIGS. 6 and 7.

Referring now to FIG. 9, there is shown a fourth embodiment of a flow rate measuring apparatus 301 suitable for measuring electrically the flow rate of an electrically conductive liquid. The apparatus 301 is similar to that shown in the previous Figures but for the provision of a different version of the measuring element 305. The measuring element 305 comprises a lid 307 having an aperture 309 for receiving a funnel (not shown) for directing the flow of urine into the vessel 303. The aperture 309 is different to that shown in the previous Figures in that it is arranged so that as urine enters the vessel 303, it is directed towards the inner wall of the vessel 303. This serves to regulate the flow of urine so that it is made less turbulent inside the vessel 303. To elaborate, as urine enters the vessel 303 on the left hand side 328 as shown on FIG. 9, any turbulence such as ripples and splashes remain on that side 328. The presence of gap 321 allows the urine level to then rise in a more laminar fashion on the other side 330 of the vessel 303, with the result that artefacts in the measurement of capacitance are reduced.

In this embodiment, the sensing element 311 is the same as the sensing element described with reference to FIGS. 1 to 5.

As can be understood from the above, the apparatus 1, 101, 201, 301 is a self contained electronic voiding diary which requires the minimum of interaction with the patient. The functional features of the apparatus 1 are all integrated into a single “insert” (comprising the lid 7, 107, 207, 307 housing the electronic circuitry 13, 113, 213, 313 and the sensing element 11, 111, 211, 311), which neatly locates with the vessel 3, 103, 203, 303. The apparatus 1, 101, 201, 301 is small, lightweight, robust and is easily handled by the patient. Moreover, the apparatus 1, 101, 201, 301 may be conveniently placed onto a toilet lid for ease of use by the patient.

The apparatus 1, 101, 201, 301 may be readily able to be located in a docking station for example, which itself may be adapted to read the stored data and recharge the power supply, when required. It is to be appreciated that the sensing element 11, 111, 211, 311 may be adapted so that when the apparatus 1, 101, 201, 301 is located in a docking station, it supports the wireless communication of data.

It is to be appreciated that although the invention has been described above with reference to the measurement of parameters associated with the flow of urine, the invention is not limited to use in this connection. In particular, the invention could be used in any situation where the liquid is electrically conductive and there is a requirement to accurately measure parameters associated with the flow of such liquid, for example in the manufacturing or process industries. It is to be appreciated that the invention could for example, alternatively be used in the calibration of sprayer nozzles, such as agricultural sprayers, where there are either legal requirements or codes of practice which set limits on the amount of chemicals used.

It will be appreciated by persons skilled in the art that the above embodiments have been described by way of example only, and not in any limitative sense, and that various alterations and modifications are possible without departing from the scope of the invention as defined by the appended claims.

1. A flow rate measuring apparatus, said apparatus comprising:
(i) a vessel for receiving electrically conductive liquid; and
(ii) a measuring element for measuring electrically the filled volume of the vessel as a function of time to provide a signal representative of the flow rate of electrically conductive liquid entering the vessel, said measuring element having a first side and a second side, wherein said measuring element is disposable within said vessel and is configured to regulate the flow of electrically conductive liquid from the first side to the second side.

2. An apparatus as claimed in claim 1, wherein said measuring element comprises a sensing element which comprises a first electrical conductor electrically insulated from electrically conductive liquid entering the vessel.

3. An apparatus as claimed in claim 1, wherein said measuring element comprises a lid having an aperture configured to direct electrically conductive fluid entering the vessel towards an inner wall of the vessel.

4. An apparatus as claimed in claim 1, wherein said apparatus further comprises a grounded electrically conductive element which is disposed at or near the base of the vessel.

5. An apparatus as claimed in claim 1, wherein said measuring element comprises a sensing element which comprises a grounded electrically conductive element, a dielectric element of a capacitor, and a first electrical conductor disposed between the grounded electrically conductive element and the dielectric element.

6. An apparatus as claimed in claim 5, wherein said measuring element further comprises an electrical insulator disposed between the grounded electrically conductive element and the first electrical conductor.

7. An apparatus as claimed in claim 2, wherein said sensing element is adapted to change its capacitance in accordance with the time-dependent amount of electrically conductive liquid in the vessel.

8. An apparatus as claimed in claim 5, wherein said apparatus is adapted so that electrically conductive liquid entering the vessel flows in a direction such that it makes contact with said dielectric element only after it has made contact with the grounded electrically conductive element.

9. An apparatus as claimed claim 2, wherein a path formed between the first side and the second side is defined by a gap between the sensing element and a wall of the vessel.

10. An apparatus as claimed in claim 2, wherein a path formed between the first side and the second side is defined by at least one aperture in the sensing element.

11. An apparatus as claimed in claim 5, wherein the sensing element additionally comprises a further electrical insulator disposed on said grounded electrically conductive element on the opposite side thereof to the first electrical conductor.

12. An apparatus as claimed in claim 1, wherein the measuring element further comprises electronic circuitry for utilizing the changes in capacitance over time as the electrically conductive liquid enters the vessel to generate a signal representative of the flow rate of the electrically conductive liquid entering the vessel.

13. An apparatus as claimed in claim 1, wherein the measuring element further comprises a data storage device which is able to store data relating to the flow rate of the electrically conductive liquid entering the vessel.

14. An apparatus as claimed in claim 13, wherein said apparatus is adapted so that data recorded on the data storage device is able to be downloaded onto a PC and analyzed using software.

15. An apparatus as claimed in claim 1, wherein said apparatus is adapted so that a user is provided with information relating to the total volume of electrically conductive liquid entering the vessel in a pre-determined time frame.

16. An apparatus as claimed in claim 1, wherein said apparatus is further adapted to provide a user with information relating to the time taken for a predetermined volume of electrically conductive liquid to enter the vessel.

17. An apparatus as claimed in claim 1, wherein said apparatus further includes a power supply.

18. An apparatus as claimed in claim 1, wherein said apparatus is adapted so that the measuring element continuously measures the filled volume of the vessel as a function of time, for a period of time.

19. A flow rate measuring apparatus, said apparatus comprising a measuring element for measuring electrically the filled volume of a vessel as a function of time to provide a signal representative of the flow rate of electrically conductive liquid entering a vessel, said measuring element having a first side and a second side, wherein said measuring element is disposable within a vessel and is configured to regulate the flow of electrically conductive liquid from the first side to the second side, and wherein said measuring element measures capacitance and includes a first electrical conductor electrically insulated from electrically conductive liquid entering the vessel, characterized in that electrically conductive liquid disposed within the vessel functions as a second plate of the capacitor.

20. (canceled)
